(19) United States
(12) Patent Application Publication
(10) Pub. No.: US 2024/0221993 A1
(43) Pub. Date: Jul. 4, 2024

(54) COIL, REACTOR, CONVERTER, POWER CONVERSION DEVICE, AND METHOD FOR MANUFACTURING A COIL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takehito KOBAYASHI, Mie (JP); Naotoshi FURUKAWA, Mie (JP); Seiji SHITAMA, Mie (JP)

(21) Appl. No.: 18/563,299

(22) PCT Filed: Jun. 1, 2022
(86) PCT No.: PCT/JP2022/022399

§ 371 Date: Nov. 21, 2023

(30) Foreign Application Priority Data
Jun. 3, 2021 (JP) 2021-093946

(51) Int. Cl. H01F 27/28; H01F 27/24; H01F 41/061

(52) U.S. Cl. CPC H01F 27/2823; H01F 27/24; H01F 41/061

(57) ABSTRACT

A coil includes a first coil portion, wherein the first coil portion includes a plurality of first turns produced by edgewise winding of a flat wire into a spiral. Each of the plurality of first turns includes a first inner peripheral portion that constructs an inner periphery side of the first turn in the flat wire and a first outer peripheral portion that constructs an outer periphery side of the first turn in the flat wire. Each first outer peripheral portion is bent so as to be inclined with respect to the first inner peripheral portion in a first direction in an axial direction of the first coil portion.

### TECHNICAL FIELD

The present disclosure relates to a coil, a reactor, a converter, a power conversion device, and a method for manufacturing a coil.

This application is based upon and claims the benefit of priority of the prior Japanese Patent Application No. 2021-093946, filed on Jun. 3, 2021, the entire contents of which are incorporated herein by reference.

### BACKGROUND

Patent Document 1 discloses an edgewise coil formed by winding a flat wire edgewise into a spiral. Patent Document 2 discloses an edgewise coil winding apparatus that iteratively performs edgewise bending of a flat wire and feeding of the flat wire to form an edgewise coil. As one example, an edgewise coil is used in a reactor, which is one of the components in a converter mounted in a vehicle, such as a hybrid vehicle.

### PRIOR ART DOCUMENT

### Patent Document

Patent Document 1: JP 2010-263079 A
Patent Document 2: JP 2017-017055 A

### SUMMARY OF THE INVENTION

A coil according to an aspect of the present disclosure includes a first coil portion, wherein the first coil portion includes a plurality of first turns produced by edgewise winding of a flat wire into a spiral, each of the plurality of first turns includes: a first inner peripheral portion that constructs an inner periphery side of the first turn in the flat wire; and a first outer peripheral portion that constructs an outer periphery side of the first turn in the flat wire, and each first outer peripheral portion is bent so as to be inclined with respect to the first inner peripheral portion in a first direction in an axial direction of the first coil portion.

A reactor according to an aspect of the present disclosure includes: the coil according to the present disclosure; and a magnetic core in which the coil is disposed.

A converter according to an aspect of the present disclosure includes the reactor according to the present disclosure.

A power conversion device according to an aspect of the present disclosure includes the converter according to the present disclosure.

A method for manufacturing a coil according to the present disclosure includes a step of forming a plurality of first turns by winding a flat wire edgewise into a spiral using a winding machine,

wherein the winding machine includes a holding unit configured to hold an inner peripheral portion, which is positioned on an inner periphery side of a bend in the flat wire, and a guiding unit configured to hold the outer peripheral portion, which is positioned on an outer periphery side of the bend in the flat wire, during edgewise bending of the flat wire, the holding unit includes a shaft that contacts a side surface of the inner peripheral portion, the guiding unit is rotatable about a center axis of the shaft, and the step of forming the first turns is performed in a state where the guiding unit is displaced with respect to the holding unit in a first direction in an axial direction of the shaft.

### BRIEF DESCRIPTION OF THE DRAWINGS

FIG. 1 is a schematic perspective view depicting one example of a coil according to the present embodiments.

FIG. 2 is a schematic front view depicting one example of a coil according to the present embodiments.

FIG. 3 is a schematic cross-sectional view depicting a cross section produced by cutting a coil according to a first embodiment along an axial direction of the coil.

FIG. 4 is a schematic cross-sectional view depicting a cross section produced by cutting a coil according to a second embodiment along an axial direction of the coil.

FIG. 5 is a schematic diagram depicting the configuration of a bending unit in a winding machine used in a method for manufacturing a coil according to the present embodiments.

FIG. 6 is a schematic diagram useful in explaining the operation of the bending unit.

FIG. 7 is another schematic diagram useful in explaining the operation of the bending unit.

FIG. 8 is a schematic diagram useful in explaining a method for manufacturing a coil according to a first embodiment.

FIG. 9 is a schematic diagram useful in explaining a method for manufacturing a coil according to a second embodiment.

FIG. 10 is a schematic diagram useful in explaining an example use of the coil according to the first embodiment.

FIG. 11 is a schematic diagram useful in explaining an example use of the coil according to the second embodiment.

FIG. 12 is a schematic plan view depicting an example of a reactor according to an embodiment.

FIG. 13 is a schematic exploded plan view depicting an example of the reactor according to the embodiment.

FIG. 14 is a block diagram schematically depicting a power supply system of a hybrid vehicle.

FIG. 15 is a circuit diagram schematically depicting an example of a power conversion device including a converter.

FIG. 16 is a schematic cross-sectional view depicting a cross section produced by cutting a conventional coil along the axial direction of the coil.

### DESCRIPTION OF EMBODIMENTS

### Technical Problem

In an edgewise coil with a plurality of turns, it is desirable for the gaps between adjacent turns to be small. A coil with large gaps between the turns is prone to springiness. A springy coil has inferior dimensional stability, with problems such as the length of the coil in the axial direction of the coil becoming shorter during use.

One object of the present disclosure is to provide a coil where the gaps between the turns in the coil can be reduced. Another object of the present disclosure is to provide a reactor including the above coil, a converter including the above reactor, and a power conversion device including the above converter. A further object of the present disclosure is to provide a method for manufacturing a coil that is capable of manufacturing a coil with small gaps between the turns in the coil.

### Advantageous Effects of Invention

In a coil according to an aspect of the present disclosure, it is possible to make the gaps between turns smaller.

A reactor according to an aspect of the present disclosure, a converter according to an aspect of the present disclosure, and a power conversion device according to an aspect of the present disclosure can be manufactured with favorable productivity.

A method for manufacturing a coil according to an aspect of the present disclosure can manufacture a coil in which the gaps between turns are small.

### Description of Embodiments of the Disclosure

By extensively studying the problems of conventional edgewise coils, the present inventors made the following discoveries.

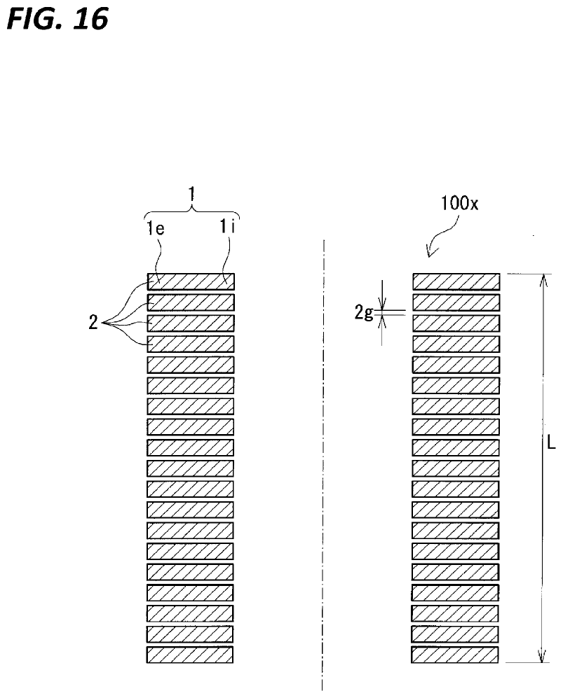

An edgewise coil is formed by a plurality of turns produced by edgewise winding of a flat wire into a spiral. FIG. 16 depicts a cross section of a conventional edgewise coil that has been cut along the axial direction of the edgewise coil. FIG. 16 depicts only the cut surfaces. In FIG. 16, configurations located to the rear of the cut surfaces are omitted. As depicted in FIG. 16, in the conventional coil 100x, a flat wire 1 that forms turns 2 is wound so that the width direction of the flat wire 1 is parallel to the radial direction of the turns 2. The flat wire 1 extends linearly in the radial direction from the inner periphery side of each turn 2 toward the outer periphery side. That is, the flat wire 1 is not bent midway in the width direction. The width direction of the flat wire 1 and the radial direction of the turns 2 are the left-right direction on the plane of the paper in FIG. 16.

By investigating the conventional coil 100x described above, the present inventors made the following discoveries.

### (1) Dimensional Stability

In the conventional coil 100x, gaps 2g are likely to be produced between adjacent turns 2. Even when the winding pitch is minimized to reduce the gaps 2g between the turns 2, the gaps 2g will still end up being produced between the turns 2. A coil 100x where the gaps 2g between the turns 2 are large will be springy. This results in poor dimensional stability, such as the overall length L of the coil 100x shortening when the coil 100x is pressed from both ends.

Deterioration of dimensional stability risks a fall in productivity when manufacturing products and a decrease in product performance. As one example, when the coil 100x is used as a component in a product such as a reactor, if the total length L of the coil 100x changes during the assembly process, the positions of both end portions of the coil 100x will change. Although not depicted in FIG. 16, at both end portions of the coil 100x, the flat wire 1 is pulled out to form terminal portions. A bus bar is connected to each of these terminal portions by welding. If the positions of both end portions change due to a fall in the total length L of the coil 100x, this can cause problems during connection operations, such as the ends of the coil 100x and the bus bars becoming separated and incapable of being welded together, or being weldable but only with insufficiently strong welds.

When the coil 100x is used in a reactor, a magnetic core is normally disposed inside the coil 100x. If the total length L of the coil 100x becomes shortened during the assembly process, there will be an increase in the exposed parts of the magnetic core that are exposed from both end portions of the coil 100x. An increase in leakage magnetic flux from these exposed parts risks deterioration in reactor loss.

### (2) Shape Stability

A coil 100x where there are gaps 2g between the turns 2 and, as described earlier, the flat wire 1 forming the turns 2 extends linearly along the radial direction of the turns 2 is susceptible to bending in the length direction of the coil 100x when a force acts in the radial direction of the coil 100x. This means that the shape stability is poor. When the coil 100x is lifted or placed on a table so that the axial direction of the coil 100x is vertical, the shape of the coil 100x is susceptible to deformation. This makes handling difficult and lowers productivity when manufacturing products.

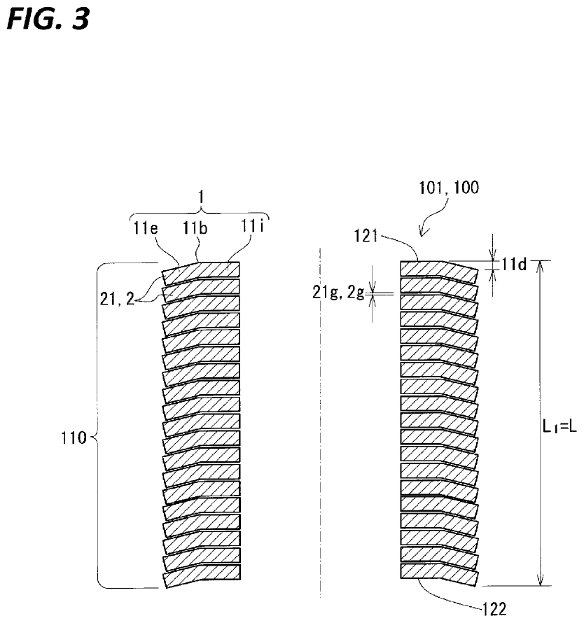

As a result of trial and error to solve the above problem, the present inventors discovered that the gaps 2g between the turns 2 can be reduced by deforming the cross-sectional shape of the flat wire 1 forming the turns 2 as depicted in FIG. 3. In more detail, it was established that by bending the flat wire 1 midway in the width direction, the gaps 2g between the turns 2 becomes smaller than in a conventional structure.

The present disclosure is based on the above findings.

First, embodiments of the present disclosure will be listed and described in brief.

(1) A coil according to an embodiment of the present disclosure includes a first coil portion, wherein the first coil portion includes a plurality of first turns produced by edgewise winding of a flat wire into a spiral, each of the plurality of first turns includes: a first inner peripheral portion that constructs an inner periphery side of the first turn in the flat wire; and a first outer peripheral portion that constructs an outer periphery side of the first turn in the flat wire, and each first outer peripheral portion is bent so as to be inclined with respect to the first inner peripheral portion in a first direction in an axial direction of the first coil portion.

In the coil according to the present disclosure, when looking at a cross section along the axial direction of the coil, the flat wire in the first turns is bent so that the first outer peripheral portion is inclined in a first direction with respect to the first inner peripheral portion. In other words, the flat wire in the first turns is bent midway in the width direction of the flat wire. With the coil according to the present disclosure, it is possible to reduce the gaps between the first turns that form the first coil portion. Since the gaps between the first turns are small, the overall length of the coil is unlikely to become shortened when the first coil portion is pressed from both ends. This means that the above coil has superior dimensional stability. The first direction is a direction from one end in the axial direction of the first coil portion toward the other end.

In the coil according to the present disclosure, in each first turn, the first outer peripheral portion of the flat wire is inclined with respect to the first inner peripheral portion. For adjacent first turns, the first outer peripheral portions of the flat wire overlap each other, which means that the shape of the coil is not susceptible to deformation even when a force acts upon the coil in the radial direction. This means the coil described above has superior shape stability.

(2) In the coil according to (1) described above, the first coil portion may be shaped as a quadrangular cylinder, each first turn may include corner portions where the flat wire is bent edgewise, and a displacement in the axial direction of the first coil portion between the first inner peripheral portion and the first outer peripheral portion at the corner portions may be 0.1 mm or more and 0.5 mm or less.

In the configuration according to (2) described above, the gaps between the first turns can be reduced because the displacement between the first inner circumferential portion and the first outer circumferential portion of the flat wire in the first turns is 0.1 mm or more. Since the displacement between the first inner circumferential portion and the first outer circumferential portion is 0.5 mm or less, it is difficult to grasp at first glance that the flat wire 1 is actually bent midway in the width direction. In other words, according to the configuration (2) above, it is possible to obtain a coil with a favorable appearance that is comparable to a conventional coil.

(3) The coil according to (1) or (2) above may further include a second coil portion that is continuously connected in the axial direction to the first coil portion, wherein the second coil portion may include a plurality of second turns produced by winding the flat wire edgewise into a spiral, each of the plurality of second turns may include: a second inner peripheral portion that constructs an inner periphery side of the second turn in the flat wire; and a second outer peripheral portion that constructs an outer periphery side of the second turn in the flat wire, and each second outer peripheral portion may be bent so as to be inclined with respect to the second inner peripheral portion in a second direction in the axial direction of the first coil portion.

In the coil according to (3) above, the first coil portion and the second coil portion are disposed so as to be continuously aligned in the axial direction of the coil. When looking at a cross section along the axial direction of the coil, the flat wire in each second turn is bent so that the second outer peripheral portion is inclined with respect to the second inner peripheral portion in a second direction. That is, the flat wire in each second turn is bent midway in the width direction of the flat wire in the same way as the first turns described above. These second turns achieve the same effects as the first turns. According to this aspect, it is possible to reduce the gaps between the second turns that form the second coil portion. The coil according to (3) described above has superior dimensional stability and shape stability. The second direction is opposite to the first direction, and is the direction from the other end toward the one end of the coil including the first coil portion.

When the coil according to (3) above is used in a reactor for example, it is possible to reduce the exposure of a magnetic core disposed inside the coil from both end portions of the coil. As a result, since leakage magnetic flux from the exposed parts of the magnetic core can be reduced, it is possible to reduce reactor loss.

(4) The coil according to (3) described above may further include at least one third turn produced by edgewise winding of the flat wire between the first coil portion and the second coil portion, wherein in each third turn, a third inner peripheral portion, which constructs an inner periphery side of the third turn in the flat wire, and a third outer peripheral portion, which constructs an outer periphery side of the third turn in the flat wire, may be flatly connected.

In the coil according to (4) above, the third turns are present between the first turns and the second turns. By including the third turns between the first turns and the second turns, it is easy to suppress excessive deformation of the flat wire when transitioning from the first turns to the second turns.

(5) In the coil according to (3) or (4) described above, the second coil portion may be shaped as a quadrangular cylinder, each second turn may include corner portions where the flat wire is bent edgewise, and a displacement in the axial direction of the second coil portion between the second inner peripheral portion and the second outer peripheral portion at the corner portions may be 0.1 mm or more and 0.5 mm or less.

In the configuration according to (5) described above, since the displacement between the second inner peripheral portion and the second outer peripheral portion of the flat wire in each second turn is 0.1 mm or more, the gaps between the second turns can be reduced. Since the displacement between the second inner circumferential portion and the second outer circumferential portion is 0.5 mm or less, it is difficult to grasp at first glance that the flat wire is actually bent midway in the width direction. In other words, with the configuration according to (5) above, it is possible to obtain a coil with a favorable appearance that is comparable to a conventional coil.

(6) A reactor according to an embodiment of the present disclosure includes: the coil according to any one of (1) to (5) described above; and a magnetic core in which the coil is disposed.

Since the reactor according to the present disclosure includes the coil described above, the reactor can be manufactured with superior productivity and is expected to have improved performance.

(7) A converter according to an embodiment of the present disclosure includes the reactor according to (6) described above.

Since the converter according to the present disclosure includes the reactor described above, the converter can be manufactured with superior productivity.

(8) A power conversion device according to an embodiment of the present disclosure includes the converter according to (7) described above.

Since the power conversion device according to the present disclosure includes the converter described above, the power conversion device can be manufactured with superior productivity.

(9) A method for manufacturing a coil according to an embodiment of the present disclosure includes a step of forming a plurality of first turns by winding a flat wire edgewise into a spiral using a winding machine, wherein the winding machine includes a holding unit configured to hold an inner peripheral portion, which is positioned on an inner periphery side of a bend in the flat wire, and a guiding unit configured to hold the outer peripheral portion, which is positioned on an outer periphery side of the bend in the flat wire, during edgewise bending of the flat wire, the holding unit includes a shaft that contacts a side surface of the inner peripheral portion, the guiding unit is rotatable about a center axis of the shaft, and the step of forming the first turns is performed in a state where the guiding unit is displaced with respect to the holding unit in a first direction in an axial direction of the shaft.

In the method for manufacturing a coil according to the present disclosure, the first coil portion can be formed by a plurality of first turns. According to the method for manufacturing described above, by forming the first turns in a state where the guiding unit is displaced in a specific direction with respect to the holding unit, the first turns in which the outer peripheral portion of the flat wire is inclined with respect to the inner peripheral portion can be formed. The method for manufacturing a coil according to the present disclosure can manufacture a coil with small gaps between the first turns by bending the flat wire that forms the first turns.

(10) In the method for manufacturing a coil according to (9) described above, in the step of forming the first turns, a displacement in the first direction of the guiding unit with the holding unit as a reference may be 0.1 mm or more and 0.5 mm or less.

The method for manufacturing a coil according to (10) described above can manufacture a coil with small gaps between the first turns and a favorable appearance.

(11) The method for manufacturing a coil according to (9) or (10) described above may further include, after the step of forming the first turns, a step of forming a plurality of second turns by winding the flat wire edgewise into a spiral, wherein the step of forming the second turns may be performed in a state where the guiding unit is displaced with respect to the holding unit in a second direction in the axial direction of the shaft.

In the method for manufacturing a coil according to (11) described above, the second coil portion can be formed by a plurality of second turns. With the manufacturing method according to (11) described above, by forming the second turns in a state where the guiding unit is displaced in a specific direction with respect to the holding unit, second turns where the outer peripheral portion of the flat wire is inclined with respect to the inner peripheral portion can be formed. In the manufacturing method according to (11) described above, by bending the flat wire forming the second turns, it is possible to manufacture a coil with small gaps between the second turns. The second direction is opposite to the first direction described above. That is, in the step of forming the second turns, the direction in which the guiding unit is displaced with respect to the holding unit is opposite to the step of forming the first turns. In the flat wire that forms the second turns, the direction in which the outer circumferential portion is inclined with respect to the inner circumferential portion is opposite to that of the flat wire forming the first turns.

(12) The method for manufacturing a coil according to (11) described above may further include, between the step of forming the first turns and the step of forming the second turns, a step of forming at least one third turn by edgewise winding of the flat wire, wherein the step of forming the third turns may be performed in a state where a position of the holding unit and a position of the guiding unit match in the axial direction of the shaft.

In the method for manufacturing a coil (12) described above, the first turns and the second turns can be joined by the third turns. According to the manufacturing method (12) described above, since the third turns are formed in a state where the guiding unit is not displaced with respect to the holding unit, the third turns can be formed so that the inner peripheral portion and the outer peripheral portion of the flat wire are flat. By forming the third turns between the first turns and the second turns, it is easy for the manufacturing method according to (12) described above to suppress excessive deformation in the flat wire when transitioning from the first turns to the second turns.

(13) In the method for manufacturing a coil according to (11) or (12), a displacement in the second direction of the guiding unit with the holding unit as a reference may be 0.1 mm or more and 0.5 mm or less in the step of forming the second turns.

The method for manufacturing a coil according to (13) described above can manufacture a coil with small gaps between the second turns and a favorable appearance.

### Detailed Description of Embodiments of the Present Disclosure

Specific examples of a coil, a method for manufacturing a coil, a reactor, converter, and a power conversion device according to the present disclosure will now be described with reference to the drawings. The same reference numerals in the drawings indicate the same or corresponding parts.

Note that the present invention is not limited to the embodiments described here and is intended to include all modifications within the meaning and scope of the range of the patent claims and their equivalents.

### <Overview of Coil>

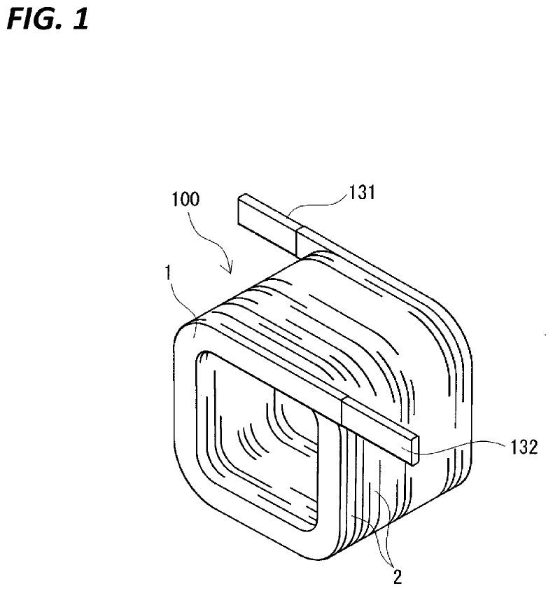

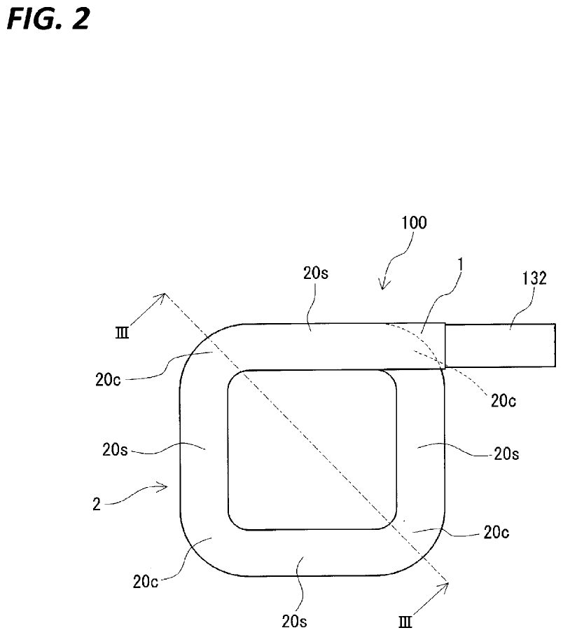

An overview of a coil 100 according to an embodiment will be described mainly with reference to FIGS. 1 and 2. The coil 100 is an edgewise coil. As depicted in FIG. 1, the coil 100 is formed of a plurality of turns 2 by winding a flat wire 1 edgewise into a spiral. FIG. 2 is a front view of the coil 100 when looking in the axial direction. In FIG. 2, illustration of terminal portions 131 of the coil 100 is omitted. The coil 100 in the present embodiment is a reactor coil.

### <Coil>

The coil 100 may be shaped as a round or polygonal cylinder. The expression “round cylinder” here means that the end faces of the coil 100 when looking in the axial direction are round. The expression “round” here also includes elliptical shapes. The expression “polygonal cylinder” here means that the end faces are polygonal. Examples of polygonal shapes include triangular, quadrangular, hexagonal, and octagonal shapes. Quadrangular shapes include rectangular shapes and trapezoidal shapes. The coil 100 according to the present embodiment is shaped as a polygonal cylinder. In more detail, the coil is a quadrangular cylindrical coil whose end faces are rectangular.

### <Flat Wire>

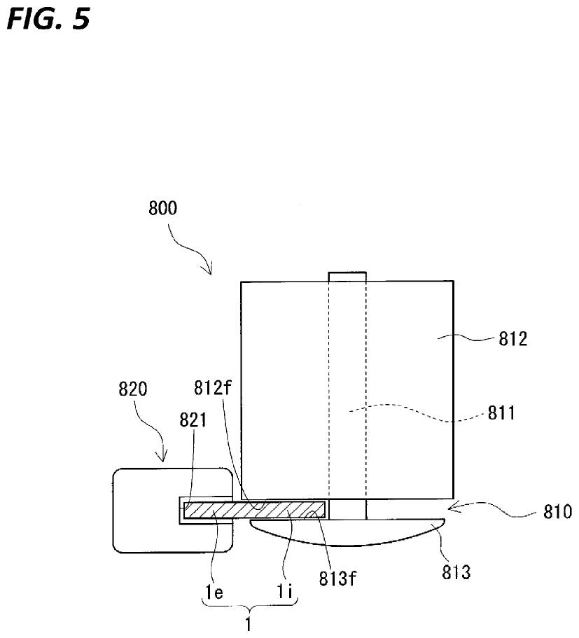

The flat wire 1 is a wire that is rectangular in cross section. The cross section referred to here is a cross section taken perpendicular to the length direction of the flat wire 1. The rectangle has a pair of short sides and a pair of long sides, like the flat wire 1 depicted in FIG. 5. The “width” of the flat wire 1 is the distance between the short sides that face each other, and corresponds to the length of each long side. The width direction of the flat wire 1 is effectively the direction along the long sides of the rectangle. The “thickness” of the flat wire 1 is the distance between the long sides that face each other and corresponds to the length of the short sides. The thickness direction of the flat wire 1 is effectively the direction along the short sides of the rectangle. The width and thickness of the flat wire 1 can be selected as appropriate according to the application. As examples, in the case of a reactor coil, the width of the flat wire 1 is 3 mm or more and 15 mm or less, or possibly 5 mm or more and 12 mm or less. As examples, the thickness of the flat wire 1 is 0.5 mm or more and 5 mm or less, or possibly 0.8 mm or more and 3 mm or less.

### <Turns>

A plurality of turns 2 are formed by winding the flat wire 1 into a spiral. The shape of each turn 2 is substantially the same as the shape of the end faces of the coil 100 described above. The shape of the turns 2 referred to here is the shape of the turns 2 when looking in the axial direction. In the present embodiment, as depicted in FIG. 2, the turns 2 are rectangular in shape. Each turn 2 has four straight portions 20s, where the flat wire 1 is disposed in a straight line, and four corner portions 20c produced by edgewise bending of the flat wire.

The number of turns 2 can be selected as appropriate according to the application. As examples for the case of a reactor coil, the number of turns 2 is 10 turns or more and 60 turns or less for example, or possibly 20 turns or more and 50 turns or less.

### First Embodiment

A coil 101 according to the first embodiment will now be described mainly with reference to FIG. 3. FIG. 3 depicts only a cross section along a line III-III indicated in FIG. 2. In FIG. 3, configurations located to the rear of the cut surfaces are omitted. The line III-III is a diagonal of a turn 2. The coil 101 includes a first coil portion 110. The first coil portion 110 includes a plurality of first turns 21 produced by edgewise winding of the flat wire 1 into a spiral. One feature of this first embodiment is that the flat wire 1 forming each first turn 21 has a specific shape. The coil 101 according to the first embodiment depicted in FIG. 3 includes only the first coil portion 110. This is described in detail below.

### (First Turns)

As depicted in FIG. 3, each of the plurality of first turns 21 includes a first inner peripheral portion 11i and a first outer peripheral portion 11e. The first inner peripheral portion 11i constructs the inner periphery side of a first turn 21 in the flat wire 1. The first outer peripheral portion 11e constructs the outer periphery side of a first turn 21 in the flat wire 1. The first outer peripheral portion 11e is bent with respect to the first inner peripheral portion 11i so as to be inclined toward a first direction in the axial direction of the first coil portion 110. In more detail, the flat wire 1 forming each first turn 21 is bent midway in the width direction of the flat wire 1. The first inner peripheral portion 11i and the first outer peripheral portion 11e are connected via a bent portion 11b. The first inner peripheral portion 11i is a part of the flat wire 1 located closer to the inner periphery side of the first turn 21 than the bent portion 11b. The first outer peripheral portion 11e is a part of the flat wire 1 located closer to the outer periphery side of the first turn 21 than the bent portion 11b. In the present embodiment, the flat wire 1 in each first turn 21 is bent midway in the width direction at both the straight portions 20s and the corner portions 20c described earlier.

In the coil 101 according to the present embodiment, by bending the flat wire 1 midway in the width direction in each first turn 21, the gaps 21g between the first turns 21 forming the first coil portion 110 can be reduced.

When looking at a cross section taken along the axial direction of the first coil portion 110, that is, the coil 101, each first inner peripheral portion 11i extends substantially along the radial direction from the inner periphery side toward the outer periphery side of each first turn 21. That is, the first inner peripheral portion 11i extends substantially parallel to the radial direction of the first turn 21. Regarding deviation in the first inner peripheral portions 11i from the radial direction, which is caused by the winding pitch of the flat wire 1, the first inner peripheral portions 11i are regarded as being along the radial direction.

The “first direction” mentioned earlier is a direction from one end in the axial direction of the first coil portion 110 to the other end. One end portion out of these two end portions of the coil 101 is assumed to be a “first end portion 121” and the other end is a “second end portion 122”. In the present embodiment, the end portion of the coil 101 located at the top in FIG. 3 is the first end portion 121 and the end portion of the coil located at the bottom is the second end portion 122. That is, the first direction is the direction from the top toward the bottom in FIG. 3. This means that in FIG. 3, the first outer peripheral portions 11e are downwardly inclined with respect to the first inner peripheral portion 11i.

As examples, the length of the first inner peripheral portion 11i in the width direction of the flat wire 1 is 30% or more and 75% or less, or possibly 40% or more and 70% or less, of the width of the flat wire 1. As examples, the length of the first outer peripheral portion 11e in the width direction of the flat wire 1 is 25% or more and 70% or less, or possibly 30% or more and 60% or less, of the width of the flat wire 1.

### <Displacement>

As examples, a displacement 11d in the axial direction of the first coil portion 110 between the first inner peripheral portion 11i and the first outer peripheral portion 11e is 0.1 mm or more and 0.5 mm or less, or possibly 0.2 mm or more and 0.4 mm or less. The displacement 11d is the displacement at corner portions of the first turns 21. The “corner portions” referred to here are the corner portions 20c appearing in FIG. 2. The displacement indicated above may be satisfied not only at the corner portions 20c, but also at the straight portions 20s.

### <Method for Measuring Displacement>

The displacement 11d can be measured as follows using a laser rangefinder for example. The coil 101 is placed on a horizontal table so that the axial direction of the coil 101 is vertical. As depicted in FIG. 3, the coil 101 is disposed so that the first end portion 121 is at the top and the second end portion 122 is at the bottom. The distance from a reference position at the top of the coil 101 to the intersection between the top surface and the side surface of the first inner peripheral portion 11i is measured. Assume that this distance is the “first distance”. The side surface of the first inner peripheral portion 11i is the inner peripheral surface of the first turn 21 and is a surface that corresponds to one short side of the rectangle in a cross section of the flat wire 1. The distance from the reference position described above to the intersection between the top surface and the side surface of the first outer peripheral portion 11e is also measured. Assume that this distance is the “second distance”. The side surface of the first outer peripheral portion 11e is the outer peripheral surface of the first turn 21 and is a surface that corresponds to the other short side of the rectangle in a cross section of the flat wire 1. Assume that the difference between the first distance and the second distance is a “displacement 11d”. This displacement 11d is measured at every corner portion 20c of the first turn 21. In the present embodiment, the displacements 11d at the four corner portions 20c depicted in FIG. 2 are measured. The average value of the measured displacement 11d at every corner portion is set as the displacement 11d at the first turns 21.

### <Gaps Between Turns>

As examples, the gaps 21g between the first turns 21 are 0.076 mm or less, or possibly 0.06 mm or less or 0.05 mm or less. A lower limit is not set because the smaller the gaps 21g, the higher the dimensional stability. That is, the lower limit is zero.

### <Method for Measuring Gaps>

The gaps 21g between the first turns 21 can be calculated as an average value of all the gaps 21g. The gaps 21g are calculated as [(L₁−n₁×t)/(n₁−1)]. Here, L₁ is the total length (in mm) of the first coil portion 110, n₁ is the number of turns (turns) for the first turns 21, and t is the thickness (in mm) of the flat wire 1.

The total length L₁ of the first coil portion 110 is measured as follows. A straight line parallel to the axial direction of the first coil portion 110 is drawn at a freely chosen position around the circumferential direction on the outer peripheral surface of the first coil portion 110. This straight line is an imaginary straight line that contacts the outer peripheral surfaces of the first turns 21. The linear distance between the first turns 21 positioned at both ends of the first turns 21 on this straight line is thereby obtained. Assume that this distance is the “total length L₁”. In the present embodiment, the total length L₁ of the first coil portion 110 is equal to the total length L of the coil 101. That is, L₁=L. The total length L₁ of the first coil portion 110, that is, the total length L of the coil 101, may be measured by placing the coil 101 on a horizontal table so that the axial direction of the coil 101 is horizontal. Measurement of the total length L of the coil 101 is performed in a state where no load is applied to the coil 101. The number of turns n₁ for the first turns 21 is the number of first turns 21 that intersect this straight line. The number of turns n₁ for the first turns 21 is equal to the number of turns 2 in the coil 101. The value (n₁−1) represents the number of gaps 21g between the first turns 21, that is, the number of gaps 2g between the turns 2. In the present embodiment, the gaps 21g can be regarded as the gaps 2g between the turns 2 in the coil 101.

In the coil 101 according to the first embodiment, it is possible to reduce the gaps 21g between the first turns 21 that form the first coil portion 110. That is, the gaps 2g between the turns 2 in the coil 101 are small. Since the gaps 21g between the first turns 21 are small, the overall length L of the coil 101 is less susceptible to shortening when the first coil portion 110 is pressed from both ends. This means that the coil 101 has superior dimensional stability.

The reason why the gaps between the first turns 21 are small is not clear, but since the flat wire 1 is bent midway in the width direction, it is assumed that a force that pulls the flat wire 1 in the bending direction acts upon the first turns 21, which makes the spaces between the first turns 21 narrower.

In each first turn 21 of the coil 101, the first outer peripheral portion 11e of the flat wire 1 is inclined with respect to the first inner peripheral portion 11i. For adjacent first turns 21, the first outer peripheral portions 11e of the flat wire 1 overlap each other, which means that the shape of the coil 101 is not susceptible to deformation even when a force acts upon the coil 101 in the radial direction. This means the coil 101 has superior shape stability.

The gaps 21g between the first turns 21 can be reduced because the displacement 11d between each first inner peripheral portion 11i and the first outer peripheral portion 11e in a first turn 21 is 0.1 mm or more. Since the displacement 11d is 0.5 mm or less, it is difficult to grasp at first glance that the flat wire 1 is actually bent midway in the width direction. That is, it is possible to obtain a coil with a favorable appearance that is comparable to a conventional coil.

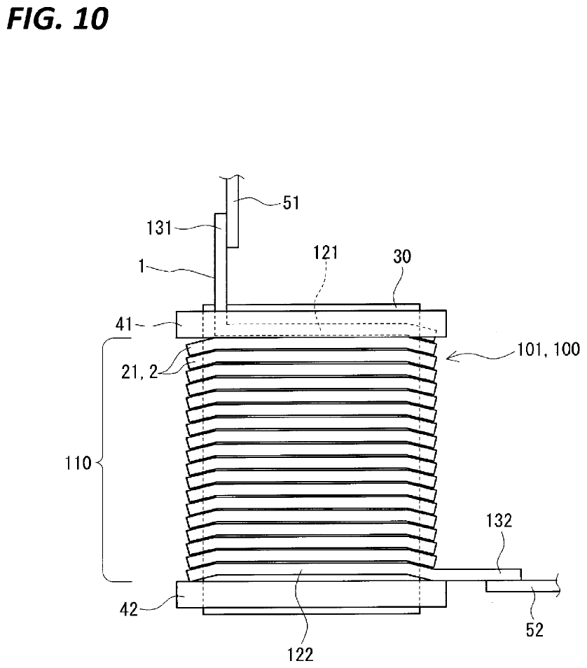

When used in a reactor, for example, the coil 101 according to the first embodiment can improve productivity when manufacturing the reactor. As depicted in FIG. 10, terminal portions 131 and 132 for connecting bus bars 51 and 52 are formed at both end portions of the coil 101. In the example in FIG. 10, holding members 41 and 42 are attached to both end portions of the coil 101. A magnetic core 30 is disposed inside the coil 101. The holding members 41 and 42 and the magnetic core 30 will be described later in a third embodiment. The bus bars 51 and 52 are used to supply power to the coil 101. The terminal portion 131 is the flat wire 1 that has been pulled out from the first end portion 121 of the coil 101. The terminal portion 132 is the flat wire 1 that has been pulled out from the second end portion 122 of the coil 101. In the present embodiment, the terminal portion 131 extends in the axial direction of the coil 101. The terminal portion 132 extends in the radial direction of the coil 101. Since the gaps between the first turns 21 of the coil 101 are small, the overall length of the coil 100 is unlikely to shorten when the coil 101 is pressed from both ends. Since the positions of the terminal portions 131 and 132 formed at both ends of the coil 101 will hardly change, a connection operation of connecting the terminal portions 131 and 132 to the bus bars 51 and 52 can be performed easily.

### Second Embodiment

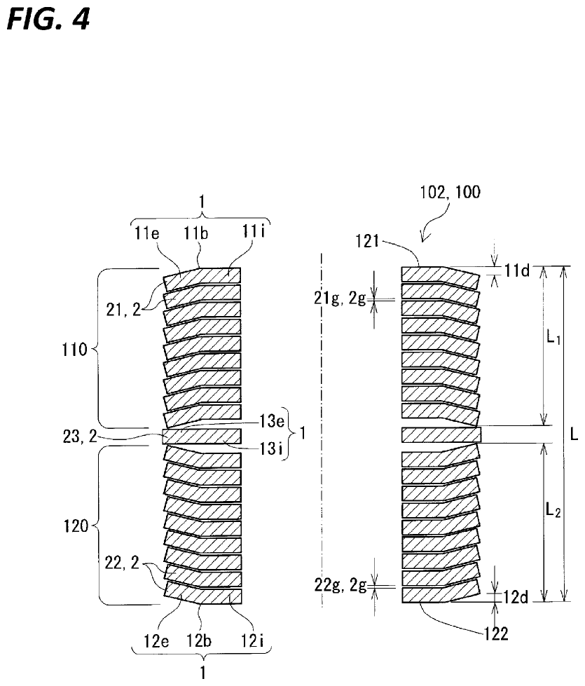

A coil 102 according to a second embodiment will now be described mainly with reference to FIG. 4. Like FIG. 3 described in the first embodiment, FIG. 4 depicts only a cross section taken along the line III-III indicated in FIG. 2. The coil 102 according to the second embodiment differs from the first embodiment by including a second coil portion 120 that is continuously connected to the first coil portion 110 described earlier. The second coil portion 120 is aligned in the axial direction of the first coil portion 110. The second coil portion 120 includes a plurality of second turns 22 produced by winding the flat wire 1 edgewise into a spiral. The flat wire 1 forming each second turn 22 has a specific shape. The following description focuses on the differences from the first embodiment. Description of the configurations that are the same as the first embodiment is omitted.

In the coil 102 according to the second embodiment, the first coil portion 110 and the second coil portion 120 are electrically connected in series and are mechanically disposed side by side in the axial direction of the coil 102. The first coil portion 110 and the second coil portion 120 are formed of one continuous flat wire 1. The first coil portion 110 and the second coil portion 120 are seamlessly composed by a series of flat wires 1. The axial direction of the first coil portion 110 and the axial direction of the second coil portion 120 match the axial direction of the coil 102.

### (Second Turns)

Each of the plurality of second turns 22 has a second inner peripheral portion 12i and a second outer peripheral portion 12e. The second inner peripheral portion 12i constructs the inner periphery side of a second turn 22 in the flat wire 1. The second outer peripheral portion 12e constructs the outer periphery side of a second turn 22 in the flat wire 1. The second outer peripheral portion 12e is bent with respect to the second inner peripheral portion 12i so as to be inclined toward the second axial direction of the first coil portion 110. In more detail, like the first turns 21 described earlier, the flat wire 1 forming each second turn 22 is bent midway in the width direction of the flat wire 1. The second inner peripheral portion 12i and the second outer peripheral portion 12e are connected via a bent portion 12b. The second inner peripheral portion 12i is a part of the flat wire 1 located closer to the inner periphery side of a second turn 22 than the bent portion 12b. The second outer peripheral portion 12e is a part of the flat wire 1 positioned closer to the outer periphery side of a second turn 22 than the bent portion 11b. In the present embodiment, the flat wire 1 in each second turn 22 is bent midway in the width direction at both the straight portions 20s and the corner portions 20c described earlier.

In the coil 102 according to the present embodiment, by bending the flat wire 1 midway in the width direction in each second turn 22, the gaps 22g between the second turns 22 forming the second coil portion 120 can be reduced.

When looking at a cross section taken along the axial direction of the second coil portion 120, that is, the coil 102, each second inner peripheral portion 12i extends substantially along the radial direction from the inner periphery side toward the outer periphery side of each second turn 22. That is, the second inner peripheral portion 12i extends substantially parallel to the radial direction of a second turn 22. Regarding deviation in the second inner peripheral portions 12i from the radial direction, which is caused by the winding pitch of the flat wire 1, the second inner peripheral portions 12i are regarded as being along the radial direction.

The “second direction” mentioned earlier is a direction from the other end in the axial direction of the coil 102 including the second coil portion 120 toward the one end mentioned earlier. That is, the second direction is opposite to the first direction described above. In the present embodiment, the second direction is the direction from the bottom toward the top in FIG. 4. That is, in FIG. 4, the second outer peripheral portions 12e are upwardly inclined with respect to the second inner peripheral portions 12i.

As examples, the length of the second inner peripheral portion 12i in the width direction of the flat wire 1 is 30% or more and 75% or less, or possibly 40% or more and 70% or less, of the width of the flat wire 1. As examples, the length of the second outer peripheral portion 12e in the width direction of the flat wire 1 is 25% or more and 70% or less, or possibly 30% or more and 60% or less, of the width of the flat wire 1.

The number of second turns 22 may be the same as or different from the number of first turns 21.

### <Displacement>

As examples, a displacement 12d in the axial direction of the second coil portion 120 between the second inner peripheral portion 12i and the second outer peripheral portion 12e may be 0.1 mm or more and 0.5 mm or less, or possibly 0.2 mm or more and 0.4 mm or less. The displacement 12d is the displacement at corner portions of the second turns 22. The “corner portions” referred to here are the corner portions 20c appearing in FIG. 2. The displacement indicated above may be satisfied not only at the corner portions 20c, but also at the straight portions 20s.

### <Method for Measuring Displacement>

The displacement 12d may be measured in the same way as the displacement 11d described earlier. The displacement 12d is measured by placing the coil 102 on a horizontal table so that the second coil portion 120 side of the coil 102, that is, the second end portion 122, faces upward. From a reference position at the top of the coil 102, a first distance to an intersection between an upper surface and a side surface of the second inner peripheral portion 12i and a second distance to an intersection between the upper surface and the side surface of the second outer peripheral portion 12e are measured. The difference between this first distance and this second distance is assumed to be the displacement 12d. The displacement 12d is measured at every corner of a second turn 22, and the average value is set as the displacement 12d at the second turns 22.

### <Gaps Between Turns>

As examples, the gaps 22g between the second turns 21 are 0.076 mm or less, or possibly 0.06 mm or less or 0.05 mm or less. A lower limit is not set because the smaller the gaps 22g, the higher the dimensional stability. That is, the lower limit is zero.

### <Method for Measuring Gaps>

The gaps 22g between the second turns 22 can be measured in the same way as the gaps 21 between the first turns 21 described earlier. The gaps 22g are calculated as [(L₂−n₂×t)/(n₂−1)]. L₂ is the total length (mm) of the second coil portion 120 and n₂ is the number of turns (turns) for the second turns 21.

In the same way as the total length L₁ of the first coil portion 110 described earlier, the total length L₂ of the second coil portion 120 may be calculated using an imaginary straight line set parallel to the axial direction of the second coil portion 120 on the outer peripheral surface of the second coil portion 120. The number of turns n₂ for the second turns 22 is the number of second turns 22 that intersect this straight line. (n₂−1) represents the number of gaps 22g between the second turns 22.

### (Third Turns)

The coil 102 according to the second embodiment additionally includes one or more third turns 23, which are produced by edgewise winding of the flat wire 1, between the first coil portion 110 and the second coil portion 120. The third turns 23 continuously connect the first coil portion 110 and the second coil portion 120. The third turns 23 are provided midway between the first turn 21 at the end of the first coil portion 110 that faces the second coil portion 120 and the second turn 22 at the end of the second coil portion 120 that faces the first coil portion 110.

Each third turn 23 includes a third inner peripheral portion 13i and a third outer peripheral portion 13e. The third inner peripheral portion 13i constructs the inner periphery side of the third turn 23 in the flat wire 1. The third outer peripheral portion 13e constructs the outer periphery side of the third turn 23 in the flat wire 1. The third inner peripheral portion 13i and the third outer peripheral portion 13e are connected so as to be flat. In more detail, the flat wire 1 in each third turn 23 is not bent midway in the width direction of the flat wire 1. When looking at a cross section along the axial direction of the coil 102, the flat wire 1 forming each third turn 23 extends linearly along the radial direction of the third turn 23. That is, the width direction of the flat wire 1 in a third turn 23 is substantially parallel to the radial direction of the third turn 23. Regarding deviation in the third inner peripheral portion 13i and the third outer peripheral portion 13e from the radial direction, which is caused by the winding pitch of the flat wire 1, the third inner peripheral portion 13i and the third outer peripheral portion 13e are regarded as being along the radial direction. The third inner peripheral portion 13i is a part located on the inner periphery side of the third turn 23 with respect to the center in the width of the flat wire 1. The third outer peripheral portion 13e is a part located closer to the outer periphery side of the third turn 23 with respect to the center in the width of the flat wire 1.

The number of third turns 23 may be one or a plural number. When a plurality of third turns are provided, the gaps between the third turns 23 tend to be larger than the gaps 21g between the first turns 21 and/or the gaps 22g between the second turns 22. The number of third turns 23 may be three turns or fewer, for example, and possibly even two turns or fewer. In the present embodiment, the number of third turns 23 is one.

In the coil 102 according to the second embodiment, the gaps 22g between the second turns 22 that form the second coil portion 120 can be reduced. In the same way as the first turns 21 described earlier, the second turns 22 are bent midway in the width direction of the flat wire 1, thereby achieving the same effects as the first embodiment described earlier. The coil 102 therefore has superior dimensional stability and shape stability.

By making the displacement 12d between the second inner peripheral portion 12i and the second outer peripheral portion 12e in each second turn 22 within the specified range described above, it is possible to reduce the gaps 22g between the second turns, and it is difficult to grasp at first glance that the flat wire 1 is actually bent midway in the width direction.

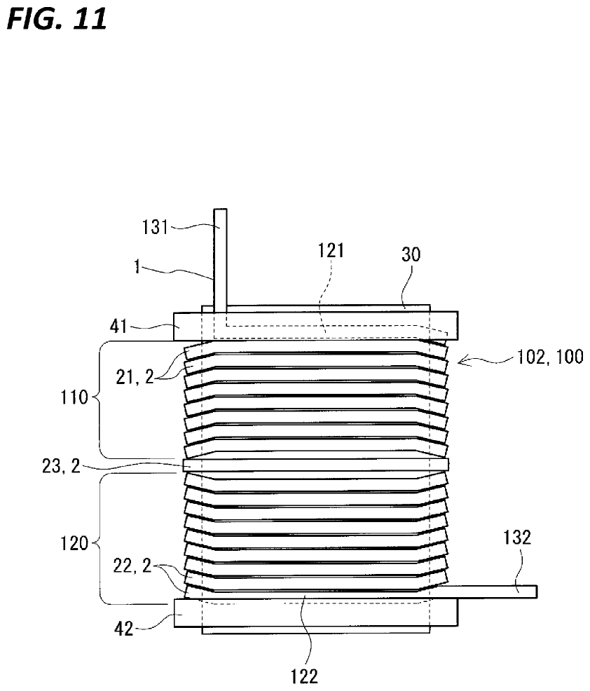

When used in a reactor, for example, the coil 102 according to the second embodiment can reduce reactor loss. Since the gaps between the first turns 21 and the gaps between the second turns 22 of the coil 102 are small, the overall length of the coil 102 is unlikely to shorten when the coil 102 is pressed from both ends. As depicted in FIG. 11, exposure of the magnetic core 30 disposed inside the coil 102 from both ends of the coil 102 can be reduced. As a result, the leakage flux from the exposed parts of the magnetic core 30 can be reduced, which means that the reactor loss can be reduced.

### <Method for Manufacturing a Coil>

A method for manufacturing a coil according to an embodiment will now be described. The method for manufacturing a coil according to the present embodiment uses a winding machine. A conventionally known winding machine can be used as this winding machine. Before describing the method for manufacturing a coil according to the present embodiment, the winding machine used in the method for manufacturing a coil according to the present embodiment will be described.

### (Winding Machine)

The winding machine includes a bending unit 800 depicted in FIG. 5 and a feeding mechanism (not illustrated). The bending unit 800 performs edgewise bending of the flat wire 1. The feeding mechanism feeds out the flat wire 1. The bending unit 800 is a principal part of the winding machine.

### <Bending Unit>

As depicted in FIG. 5, the bending unit 800 includes a holding unit 810 and a guiding unit 820. The holding unit 810 holds the inner peripheral portion 1i of the flat wire 1. The inner peripheral portion 1i of the flat wire 1 is a part located on the inner periphery side of the bend in the flat wire 1 when edgewise bending is performed on the flat wire 1. The guiding unit 820 holds the outer peripheral portion 1e of the flat wire 1. The outer peripheral portion 1e of the flat wire 1 is a part of the flat wire 1 located on the outer periphery side of the bend.

### <Holding Unit>

The holding unit 810 includes a shaft 811 and a support 812 that supports the shaft 811. The shaft 811 is a cylindrical member that contacts a side surface of the inner peripheral portion 1i of the flat wire 1. The side surface of the inner peripheral portion 1i is a surface that corresponds to one short side of the rectangle in a cross section of the flat wire 1. The support 812 is tubular. The shaft 811 passes through the center of the support 812. The shaft 811 is slidable with respect to the support 812 in the axial direction of the shaft 811. A front end of the shaft 811 protrudes from an end surface of the support 812. A disc-shaped flange 813 is provided at the front end of the shaft 811. The support 812 and the flange 813 are disposed at a distance from each other.

The holding unit 810 includes a first surface 812f composed of an end surface of the support 812 and a second surface 813f composed of a surface of the flange 813 that faces the support 812. The first surface 812f and the second surface 813f are disposed facing each other so as to sandwich the inner peripheral portion 1i of the flat wire 1 in the thickness direction. The inner peripheral portion 1i of the flat wire 1 passes between the first surface 812f and the second surface 813f and is held. Slight clearance is provided between the first surface 812f and the inner peripheral portion 1i and between the second surface 813f and the inner peripheral portion 1i so that the flat wire 1 can pass through when the flat wire 1 is fed.

### <Guiding Unit>

The guiding unit 820 is rotatable around a central axis of the shaft 811. A guide channel 821 is formed in the guiding unit 820 so as to sandwich the inner peripheral portion 1i of the flat wire 1 in the thickness direction. The outer peripheral portion 1e of the flat wire 1 passes through the guide channel 821 and is held. The width of the guide channel 821 is slightly larger than the thickness of the outer peripheral portion 1e of the flat wire 1 to allow the flat wire 1 to pass through when the flat wire 1 is fed.

In the present embodiment, the guiding unit 820 is capable of sliding with respect to the holding unit 810 in the axial direction of the shaft 811. The position of the guiding unit 820 is controlled for example by a driving apparatus (not illustrated). As one example, this driving apparatus is a servo motor.

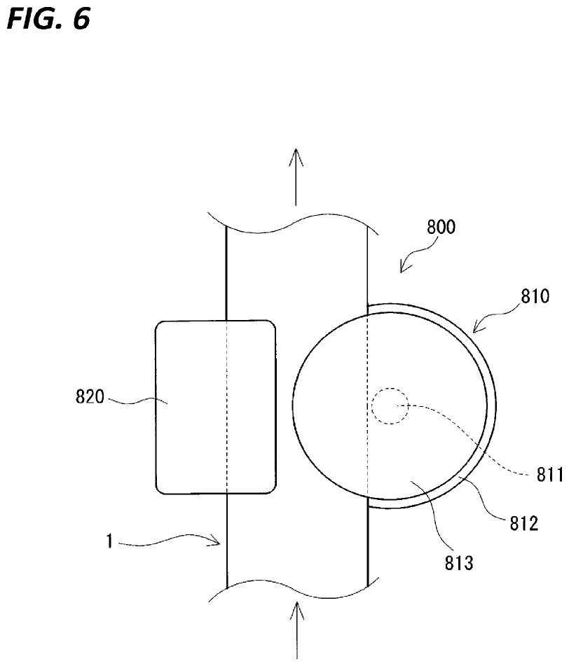

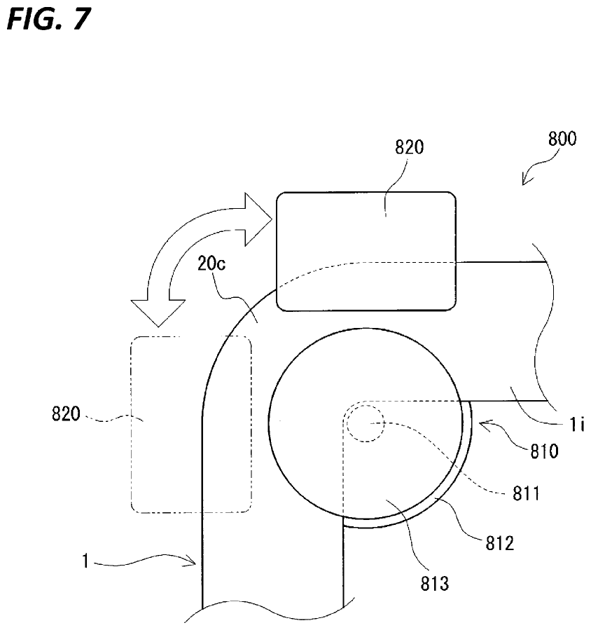

The operation of the bending unit 800 during edgewise bending of the flat wire 1 will now be described with reference to FIGS. 6 and 7. Here, the case when the quadrangular cylindrical coil 100 depicted in FIGS. 1 and 2 is formed will be described as an example. FIGS. 6 and 7 are views of the bending unit 800 in the axial direction of the shaft 811 from the flange 813 side, that is, from below. As depicted in FIG. 6, the flat wire 1 is linearly fed by a feeding mechanism, not illustrated. The arrows in FIG. 6 indicate the feeding direction of the flat wire 1. Next, as depicted in FIG. 7, the guiding unit 820 is rotated around the center axis of the shaft 811. The side surface of the inner peripheral portion 1i is pressed against the outer peripheral surface of the shaft 811, which bends the flat wire 1 around the outer peripheral surface of the shaft 811. By doing so, the flat wire 1 is bent edgewise to form one corner portion 20c. In the present embodiment, the flat wire 1 is bent by 90 degrees by rotating the guiding unit 820 by 90 degrees. By repeating this operation, one turn 2 is formed. A rectangular turn 2 is formed by repeating the feeding out and edgewise bending of the flat wire 1 four times. By forming a plurality of turns 2 by repeatedly forming a single turn 2 a plurality of times, the coil 100 is formed.

During feeding of the flat wire 1, as depicted in FIG. 5, the support 812 and the flange 813 are held at a distance so that gaps are formed to the inner peripheral portion 1i of the flat wire 1. During edgewise bending of the flat wire 1, the gap between the support 812 and the flange 813 is closed so that the inner peripheral portion 1i of the flat wire 1 becomes clamped from above and below. When the flat wire 1 is bent edgewise, the inner periphery side of the bend deforms so as to swell in the thickness direction, which makes the inner peripheral portion 1i thicker. However, by clamping the inner peripheral portion 1i of the flat wire 1 between the support 812 and the flange 813 in the thickness direction of the flat wire 1, it is possible to prevent the inner peripheral portion 1i of the flat wire 1 from becoming thicker during the edgewise bending.

Normally when a coil is produced using a winding machine, the positional relationship between the holding unit 810 and the guiding unit 820 is set so that the position where the inner peripheral portion 1i of the flat wire 1 is held and the position where the outer peripheral portion 1e of the flat wire 1 substantially match in the axial direction of the shaft 811 as depicted in FIG. 5. That is, the guiding unit 820 is positioned with respect to the holding unit 810 so that the inner peripheral portion 1i and the outer peripheral portion 1e of the flat wire 1 are flat. The position of the guide portion 820 at this time is a reference position of the guide portion 820. The expression “reference position” refers to a position where a center line between the first surface 812f and the second surface 813f when the holding unit 810 holds the inner peripheral portion 1i of the flat wire 1 and a center line in the width of the guide channel 821 of the guiding unit 820 are aligned. When the flat wire 1 in this state is wound edgewise into a spiral, the conventional coil 100x depicted in FIG. 16 is produced.

### Method for Manufacturing a Coil According to the First Embodiment

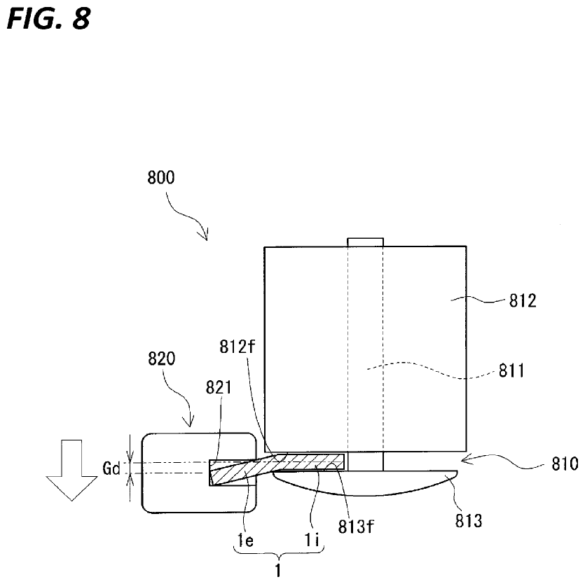

A method for manufacturing a coil according to the first embodiment for manufacturing the coil 101 depicted in FIG. 3 will now be described. The method for manufacturing a coil according to the first embodiment includes a step of edgewise winding the flat wire 1 into a spiral using a winding machine to form a plurality of the first turns 21. One characteristic of the method for manufacturing a coil according to the first embodiment is that the first turns 21 are formed in a state where the guiding unit 820 is displaced as depicted in FIG. 8 in a specific direction with respect to the holding unit 810. The following detailed description is based on FIG. 8, with appropriate reference to FIG. 3.

### (Step of Forming First Turns)

The step of forming the first turns 21 is performed in a state where the guiding unit 820 is displaced with respect to the holding unit 810 in the first direction in the axial direction of the shaft 811. When only the first coil portion 110 is provided like in the coil 101 depicted in FIG. 3, the first direction described above may be either direction along the axis of the shaft 811. In the present embodiment, the guiding unit 820 is displaced downward with respect to the holding unit 810 by sliding the guiding unit 820 downward with the holding unit 810 as a reference. That is, the first direction is the direction from the top toward the bottom in FIG. 8. By displacing the guiding unit 820 downward with respect to the holding unit 810 in this way, the flat wire 1 is bent so that the outer peripheral portion 1e of the flat wire 1 is inclined downward with respect to the inner peripheral portion 1i. By forming the first turns 21 in this state, as depicted in FIG. 3, first turns 21 where the first outer peripheral portion 11e is inclined downward with respect to the first inner peripheral portion 11i can be formed. By forming the plurality of first turns 21, the coil 101 that includes the first coil portion 110 can be manufactured.

By displacing the guiding unit 820 with respect to the holding unit 810, the flat wire 1 that forms the first turns 21 is bent midway in the width direction. By doing so, the gaps between the first turns 21 are reduced. Although the reason for this is not clear, it is assumed that when the flat wire 1 is bent, a pulling force acts on to the first turns 21 in the direction in which the flat wire 1 is bent, which narrows the gaps between the first turns 21.

As examples, the width of the inner peripheral portion 1i of the flat wire 1 held by the holding unit 810 is 30% or more and 75% or less, or possibly 40% or more and 70% or less, of the width of the flat wire 1. As examples, the width of the outer peripheral portion 1e of the flat wire 1 held by the guiding unit 820 is 25% or more and 70% or less, or possibly 30% or more and 60% or less, of the width of the flat wire 1.

### <Displacement>

As examples, the displacement Gd of the guiding unit 820 in the first direction with the holding unit 810 as a reference may be 0.1 mm or more and 0.5 mm or less, or possibly 0.2 mm or more and 0.4 mm or less.

The flat wire 1 is wound edgewise while maintaining the displacement Gd not only at the corner portions 20c depicted in FIG. 2 of the first turns 21 but also at the straight portions 20s. By doing so, it is possible to perform bending at both the corner portions 20c and the straight portions 20s so that the first outer peripheral portion 11e is inclined with respect to the first inner peripheral portion 11i.

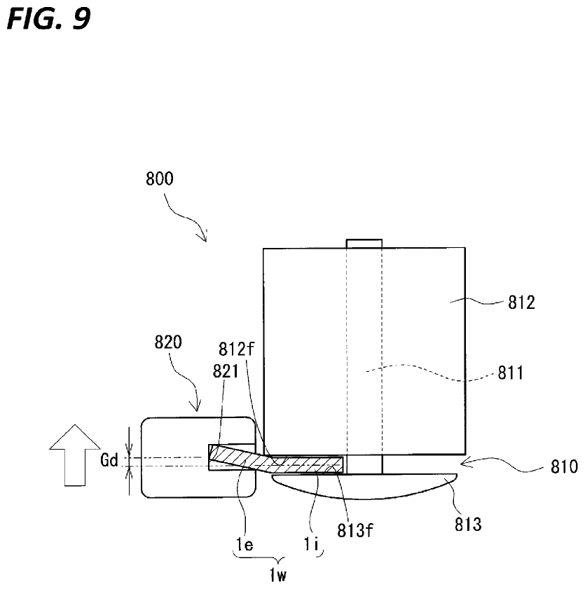

Unlike the present embodiment, as depicted in FIG. 9, the guiding unit 820 may be slid upward to displace the guiding unit 820 upward with respect to the holding unit 810. In other words, the first direction is reversed from the present embodiment and is set as the direction from the bottom to the top. In this case, the flat wire 1 becomes bent so that the outer peripheral portion 1e of the flat wire 1 is inclined upward with respect to the inner peripheral portion 1i. By forming the first turns 21 in this state, it is possible to form the first turns 21 where the first outer peripheral portion 11e is inclined upward with respect to the first inner peripheral portion 11i. This state is upside down compared to the coil 101 depicted in FIG. 3.

The method for manufacturing a coil according to the first embodiment can manufacture the coil 101 depicted in FIG. 3 that includes the first coil portion 110 formed by a plurality of the first turns 21. This method for manufacturing a coil according to the first embodiment can manufacture the coil 101 that has small gaps between the first turns 21.

By setting the displacement Gd in the first direction of the guiding unit 820 within the specific range indicated above, the power conversion device 1 can be bent so that the displacement 11d between the first inner peripheral portion 11i and the first outer peripheral portion 11e in each first turn 21 is within the predetermined range. By doing so, it is possible to manufacture the coil 101 that has a favorable appearance and in which the gaps 21g between the first turns 21 is small.

### Method for Manufacturing a Coil According to the Second Embodiment

A method for manufacturing a coil according to the second embodiment for manufacturing the coil 102 depicted in FIG. 4 will now be described. The method for manufacturing a coil according to the second embodiment includes, after the step of forming the first turns 21 according to the first embodiment described above, a step of winding the flat wire 1 edgewise into a spiral to form a plurality of second turns 22. In addition, the method for manufacturing a coil according to the second embodiment includes, between the step of forming the first turns 21 and the step of forming the second turns 22, a step of edgewise winding the flat wire 1 to form one or more third turns 23. The following detailed description is based on FIG. 9, with appropriate reference to FIG. 4.

### (Step of Forming Second Turns)

The step of forming the second turns 22 is performed in a state where the guiding unit 820 is displaced as depicted in FIG. 9 with respect to the holding unit 810 in the second direction along the axis of the shaft 811. This second direction is opposite to the first direction in the step of forming the first turns 21 described above. In the present embodiment, the guiding unit 820 is displaced upward with respect to the holding unit 810 by sliding the guiding unit 820 upward. That is, the second direction is the direction from the bottom to the top in FIG. 9. By displacing the guiding unit 820 upward with respect to the holding unit 810 in this way, the flat wire 1 is bent so that the outer peripheral portion 1e of the flat wire 1 is inclined upward with respect to the inner peripheral portion 1i. By forming the second turns 22 in this state, as depicted in FIG. 4, the second turns 22 where the second outer peripheral portion 12e is inclined upward with respect to the second inner peripheral portion 12i can be formed. By forming the plurality of second turns 22, the coil 102 including the second coil portion 120 that is continuously connected to the first coil portion 110 can be manufactured.

### <Displacement>

As examples, the displacement Gd of the guiding unit 820 in the second direction with reference to the holding portion 810 may be 0.1 mm or more and 0.5 mm or less, or possibly 0.2 mm or more and 0.4 mm or less.

The flat wire 1 is wound edgewise while maintaining the displacement Gd not only at the corner portions 20c depicted in FIG. 2 of the second turns 22 but also at the straight portions 20s. By doing so, it is possible to perform bending at both the corner portions 20c and the straight portions 20s so that the second outer peripheral portion 12e is inclined with respect to the second inner peripheral portion 12i.

### (Step of Forming Third Turns)

The step of forming the third turns 23 is performed with the position of the holding unit 810 and the position of the guiding unit 820 aligned in the axial direction of the shaft 811 as depicted in FIG. 5. That is, the position of the guiding unit 820 is set at the reference position of the guide portion 820 mentioned above. By forming the third turns 23 in this state, as depicted in FIG. 4, the third turns 23 can be formed so that the third inner peripheral portion 13i and the third outer peripheral portion 13e are flat.

The number of third turns 23 may be one or a plural number. When the third turns 23 are formed, the gap between the first turns 21 and the third turns 23 and the gap between the second turns 22 and the third turns 23 tend to be larger than the gaps 21g between the first turns 21 and the gaps 22g between the second turns 22. As examples, the number of third turns 23 may be, three turns or fewer, or possibly two turns or fewer. In the present embodiment, one third turn 23 is formed.

The method for manufacturing a coil according to the second embodiment can form the second coil portion 120 composed of the plurality of second turns 22 and can manufacture the coil 102 depicted in FIG. 4 that includes the first coil portion 110 and the second coil portion 120. The method for manufacturing a coil according to the second embodiment can manufacture the coil 102 in which the gaps 21g between the first turns 21 and the gaps 22g between the second turns 22 are small. In addition, the first turns 21 and the second turns 22 can be joined by the third turns 23. By forming the third turns 23 between the first turns 21 and the second turns 22, it becomes easy to suppress excessive deformation of the flat wire 1 when transitioning from the first turns 21 to the second turns 22.

### Experimental Example 1

The coil 101 according to the first embodiment was manufactured by the method for manufacturing a coil according to the first embodiment described above. The relationship between the displacement Gd of the guiding unit 820 depicted in FIG. 8 and the displacement 11d between the first inner peripheral portion 11i and the first outer peripheral portion 11e in the first turns 21 depicted in FIG. 3 was then investigated.

The specification of the coil 101 to be manufactured was as follows. The shape of the coil 101 was a quadrangular cylinder. The shape of the end surfaces of the coil 101 was rectangular. The number of first turns 21 to be formed was sixteen turns.

The width of the inner peripheral portion 1i of the flat wire 1 held by the holding unit 810 is around 60% of the width of the flat wire 1. The width of the outer peripheral portion 1e of the flat wire 1 held by the guiding unit 820 was set at around 30% of the width of the flat wire 1. The first turns 21 were formed in a state where the guiding unit 820 is downwardly displaced with respect to the holding unit 810. The displacement Gd of the guiding unit 820 was set at 0.2 mm. The manufactured coil 101 is referred to as “Sample No. 1”.

For Sample No. 1, the displacement 11d between the first inner peripheral portion 11i and the first outer peripheral portion 11e in the first turns 21 was measured. The displacement 11d was measured using the method for measuring the displacement described earlier. The displacement 11d at each of the four corners 20c was measured, and the average value was calculated. As a result, the displacement 11d at the corner portions 20c of the first turns 21 was around 0.2 mm on average. From this result, it was confirmed that the displacement 11d between the first inner peripheral portion 11i and the first outer peripheral portion 11e in the first turns 21 can be controlled by the displacement Gd of the guiding unit 820. The appearance of Sample No. 1 was visually inspected. As a result, it was not apparent at first glance that the flat wire in the first turns 21 was bent midway in the width direction.

In addition, each displacement was measured at the midpoint of the four straight portions 20s, and the average value was calculated. In more detail, the midpoint of each straight portion 20s is the midpoint of the length of each straight portion 20s along the circumferential direction of the first turn 21. As a result, the displacement at the straight portions 20s of the first turns 21 was around 0.1 mm on average. The reason why the displacement at the straight portions 20s was smaller than the displacement at the corner portions 20c is believed to be as follows. Since the inner peripheral portion 1i of the flat wire 1 is sandwiched between the support 812 and the flange 813 during the edgewise bending, the inner peripheral portion 1i is fixed. This means that the flat wire 1 is easy to bend at the corner portions 20c. On the other hand, at the straight portions 20s, the support 812 and the flange 813 are held at a distance so that gaps are formed between these components and the inner peripheral portion 1i, which makes it difficult to apply a bending force to the flat wire 1 compared to the corner portions 20c. It is believed that due to this relationship between the flat wire 1, the holding unit 810, and the guiding unit 820, the displacement at the straight portions 20s is smaller than the displacement at the corner portions 20c.

### Experimental Example 2

The gaps between turns were measured for Sample No. 1 of Experimental Example 1 using the method for measuring gaps described earlier.

In addition, the coil 102 according to the second embodiment depicted in FIG. 4 was manufactured by the method for manufacturing a coil according to the second embodiment described earlier. In the specification of the coil 102 to be manufactured, the number of first turns 21 was sixteen turns, the number of second turns 22 was fifteen turns, and the number of third turns was one turn. Other aspects were the same as Sample No. 1. The displacement Gd in the step of forming the first turns 21 and the step of forming the second turns 22 was set at 0.2 mm. The manufactured coil 102 is referred to as “Sample No. 2”.

A conventional coil 100x depicted in FIG. 16 was also manufactured. The specification of the manufactured coil 100x is the same as Sample No. 1. The manufactured coil 100x is referred to as “Sample No. 10”.

The gaps between turns were also measured in Sample No. 2 and Sample No. 10. As a result, Sample No. 1 was 0.03 mm, Sample No. 2 was 0.03 mm, and Sample No. 10 was 0.06 mm. This means that the gaps were smaller in Sample No. 1 and Sample No. 2 than in Sample No. 10. From this, it was understood that the gaps between the turns 2 can be reduced by bending the flat wire 1 midway in the width direction when forming the turns 2.

### Third Embodiment

### <Reactor>

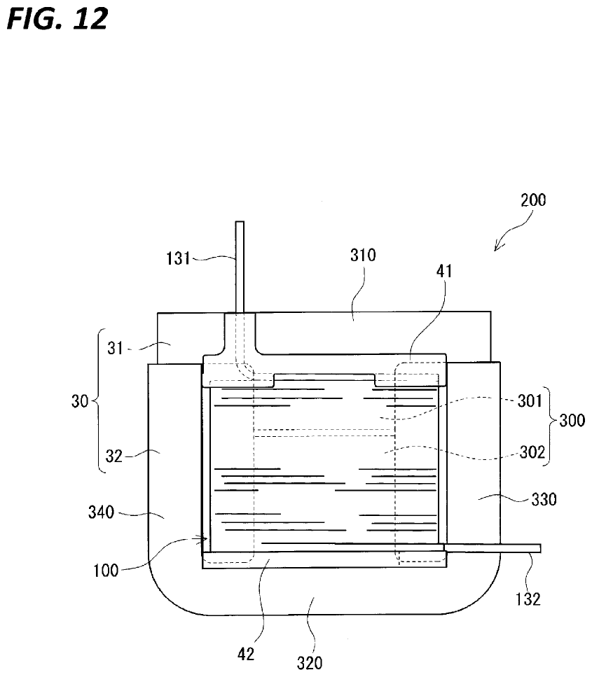

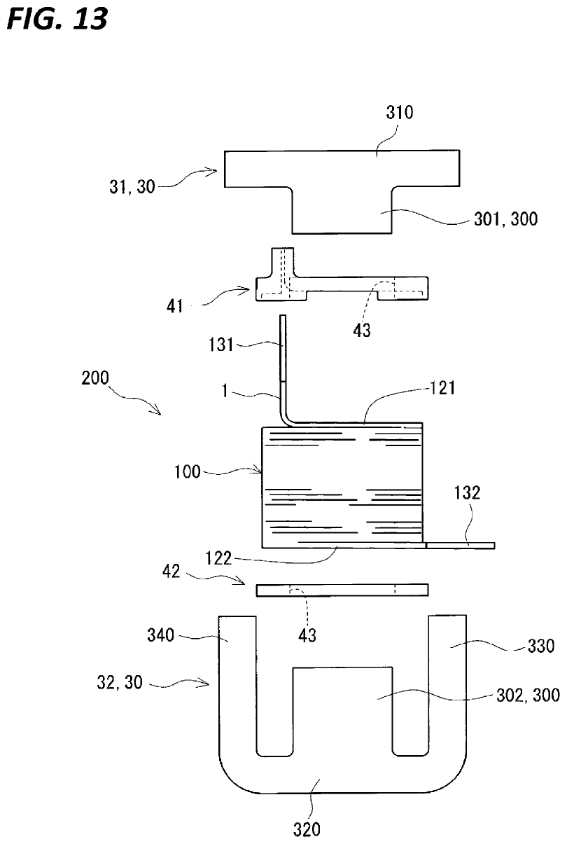

A reactor 200 according to an embodiment will now be described with reference to FIGS. 12 and 13. As depicted in FIGS. 12 and 13, the reactor 200 includes the coil 100 and the magnetic core 30. The magnetic core 30 is a combination of a first core 31 and a second core 32. The magnetic core 30 is configured with an overall shape like the Greek letter theta (θ) by combining the first core 31 and the second core 32. The configuration of the reactor 200 will be described in detail later.

### (Coil)

The coil 100 is a coil 100 according to the embodiments described earlier. In more detail, the coil 100 is the coil 101 according to the first embodiment depicted in FIG. 3 or the coil 102 according to the second embodiment depicted in FIG. 4.

### (Magnetic Core)

As depicted in FIGS. 12 and 13, the magnetic core 30 includes a middle core portion 300, a first end core portion 310, a second end core portion 320, a first side core portion 330, and a second side core portion 340.

### <Middle Core Portion>

The middle core portion 300 is the part of the magnetic core 30 that is disposed inside the coil 100. The middle core portion 300 in the present embodiment is divided into two parts in the axial direction of the middle core portion 300 and includes a first middle core portion 301 and a second middle core portion 302. The middle core portion 300 may include a gap portion. This gap portion can be provided between the first middle core portion 301 and the second middle core portion 302.

### <First End Core Portion and Second End Core Portion>

The first end core portion 310 is a part of the magnetic core 30 that faces the first end portion 121 of the coil 100. The second end core portion 320 is a part that faces the second end portion 122 of the coil 100. The first end core portion 310 and the second end core portion 320 are disposed at an interval so as to sandwich the coil 100 from the axial direction.

### <First Side Core Portion and Second Side Core Portion>

The first side core portion 330 and the second side core portion 340 are parts of the magnetic core 30 that are disposed outside the coil 100 so as to sandwich the middle core portion 300. The first side core portion 330 and the second side core portion 340 are disposed at an interval so as to sandwich both side surfaces along the axial direction of the coil 100. The first side core portion 330 and the second side core portion 340 are sufficiently long to connect the first end core portion 310 and the second end core portion 320.

### <First Core and Second Core>

The magnetic core 30 is constructed by a combination of the first core 31 and the second core 32. The respective shapes of the first core 31 and the second core 32 can be selected from various combinations. The magnetic core 30 in the present embodiment is an E-T type where an E-shaped second core 32 and a T-shaped first core 31 are combined. Other example combinations include a E-U type, an E-I type, and a T-U type.

In the present embodiment, the first core 31 includes the first end core portion 310 and the first middle core portion 301 that is part of the middle core portion 300. The first end core portion 310 and the first middle core portion 301 are integrally molded. The second core 32 includes the second end core portion 320, the second middle core portion 302, which is the remaining part of the middle core portion 300, and the entire first side core portion 330 and second side core portion 340. The second end core portion 320, the second middle core portion 302, the first side core portion 330, and the second side core portion 340 are integrally formed.

### (Holding Members)

The present embodiment further includes two holding members 41 and 42. The holding member 41 is disposed on the first end portion 121 side of the coil 100. The holding member 42 is disposed on the second end portion 122 side of the coil 100. The holding members 41 and 42 ensure that the coil 100 is electrically insulated from the first end core portion 310 and the second end core portion 320 of the magnetic core 30. The holding members 41 and 42 are formed with through holes 43 into which the respective end portions of the middle core portion 300 are inserted.

By including the coil 101 or the coil 102 according to the embodiments described above, the reactor 200 according to the present embodiment can be manufactured with superior productivity and is expected to have improved performance.

### Fourth Embodiment

### <Converter and Power Conversion Device>

The reactor 200 according to the third embodiment can be used in applications where the current satisfies the following conditions. Example current conditions are a maximum DC current of approximately 100 A or higher and 1000 A or lower, an average voltage of approximately 100 V or higher and 1000 V or lower, and a working frequency of approximately 5 kHz or higher and 100 kHz or lower. The reactor 200 according to the third embodiment can be typically used as a component in a converter mounted in a vehicle, such as an electric vehicle or a hybrid vehicle, or as a component in a power conversion device equipped with such a converter.

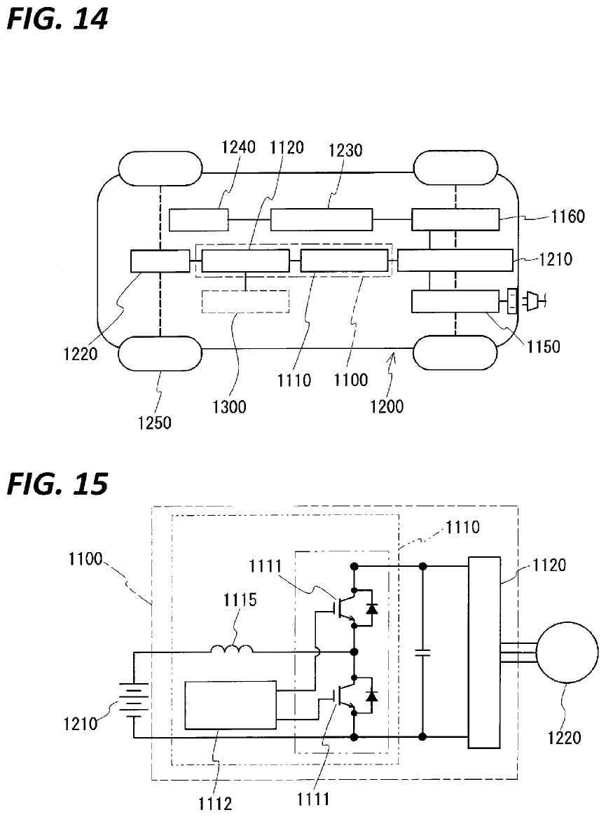

As depicted in FIG. 14, a vehicle 1200, such as a hybrid vehicle or an electric vehicle, includes a main battery 1210, a power conversion device 1100 connected to the main battery 1210, and a motor 1220 that is driven by power supplied from the main battery 1210 and is used to propel the vehicle. The motor 1220 is typically a three-phase AC motor that drives wheels 1250 during propulsion and functions as a generator during regeneration. In the case of a hybrid vehicle, the vehicle 1200 includes an engine 1300 in addition to the motor 1220. In FIG. 14, an inlet is depicted as a charging point of the vehicle 1200, but it is also possible for the vehicle to be provided with a plug.

The power conversion device 1100 includes a converter 1110 that is connected to the main battery 1210 and an inverter 1120 that is connected to the converter 1110 and performs bidirectional conversion between direct current and alternating current. When the vehicle 1200 is running, the converter 1110 depicted in this example boosts the input voltage of the main battery 1210 from around 200 V to 300 V to around 400 V to 700 V and supplies the boosted voltage to the inverter 1120. During regeneration, the converter 1110 steps down the input voltage outputted from the motor 1220 via the inverter 1120 to a suitable DC voltage for the main battery 1210 and charges the main battery 1210. This input voltage is a DC voltage. When the vehicle 1200 is running, the inverter 1120 converts the direct current that has been boosted by the converter 1110 into a predetermined alternating current and supplies the resulting power to the motor 1220. During regeneration, the inverter 1120 converts the alternating current outputted from the motor 1220 into direct current and outputs the direct current to the converter 1110.

As depicted in FIG. 15, the converter 1110 includes a plurality of switching elements 1111, a drive circuit 1112 that controls the operation of the switching elements 1111, and a reactor 1115, and converts the input voltage by repeatedly switching on and off. The “conversion” of the input voltage here refers to boosting (stepping up) and stepping down. Power devices, such as field effect transistors or insulated gate bipolar transistors, are used for the switching elements 1111. The reactor 1115 has a function that uses the property of a coil in obstructing changes in the current that flows to a circuit to smooth such changes when the current increases or decreases due to switching operations. The reactor 200 according to the third embodiment is provided as the reactor 1115. By including the reactor 200 that can be manufactured with superior productivity, the power conversion device 1100 and the converter 1110 can also be manufactured with superior productivity.

In addition to the converter 1110, the vehicle 1200 includes a power supply device converter 1150, which is connected to the main battery 1210, and an auxiliary power supply converter 1160, which is connected to a sub battery 1230 that serves as a power supply for auxiliary equipment 1240 and the main battery 1210 and converts the high voltage of the main battery 1210 to a low voltage. Although the converter 1110 typically performs DC-DC conversion, the power supply device converter 1150 and the auxiliary power supply converter 1160 perform AC-DC conversion. However, there are also power supply device converters 1150 that perform DC-DC conversion. Reactors with the same configuration as the reactor 200 according to the third embodiment but with sizes and shapes that have been changed as appropriate can be used for the reactors of the power supply device converter 1150 and the auxiliary power converter 1160. The reactor 200 according to the third embodiment can also be used for a converter that converts input power and that only steps up or only steps down.

### LIST OF REFERENCE NUMERALS

100, 101, 102, 100x Coil
110 First coil portion
120 Second coil portion
121 First end portion
122 Second end portion
131, 132 Terminal portion
1 Flat wire
1i Inner peripheral portion
1e Outer peripheral portion
11i First inner peripheral portion
11e First outer peripheral portion
11b Bent portion
12i Second inner peripheral portion
12e Second outer peripheral portion
12b Bent portion
13i Third inner peripheral portion
13e Third outer peripheral portion
11d, 12d Displacement
2 Turn
20s Straight portion
20c Corner portion
21 First turn
22 Second turn
23 Third turn
2g, 21g, 22g Gap
200 Reactor
30 Magnetic core
31 First core
32 Second core
300 Middle core portion
301 First middle core portion
302 Second middle core portion
310 First end core portion
320 Second end core portion
330 First side core portion
340 Second side core portion
41, 42 Holding member
43 Through hole
51, 52 Bus bar
800 Bending unit
810 Holding unit
811 Shaft
812 Support
813 Flange
812f First surface
813f Second surface
820 Guiding unit
821 Guide channel
1100 Power conversion device
1110 Converter
1111 Switching element
1112 Drive circuit
1115 Reactor
1120 Inverter
1150 Power supply device converter
1160 Auxiliary power supply converter
1200 Vehicle
1210 Main battery
1220 Motor
1230 Sub-battery
1240 Auxiliary equipment
1250 Wheel
1300 Engine
Gd Displacement
L Total length of coil
L₁ Total length of first coil portion
L₂ Total length of second coil portion

1. A coil comprising a first coil portion,
wherein the first coil portion includes a plurality of first turns produced by edgewise winding of a flat wire into a spiral,
each of the plurality of first turns includes:
a first inner peripheral portion that constructs an inner periphery side of the first turn in the flat wire; and
a first outer peripheral portion that constructs an outer periphery side of the first turn in the flat wire, and
each first outer peripheral portion is bent so as to be inclined with respect to the first inner peripheral portion in a first direction in an axial direction of the first coil portion.

2. The coil according to claim 1,
wherein the first coil portion is shaped as a quadrangular cylinder,
each first turn includes corner portions where the flat wire is bent edgewise, and
a displacement in the axial direction of the first coil portion between the first inner peripheral portion and the first outer peripheral portion at the corner portions is 0.1 mm or more and 0.5 mm or less.

3. The coil according to claim 1,
further comprising a second coil portion that is continuously connected in the axial direction to the first coil portion,
wherein the second coil portion includes a plurality of second turns produced by winding the flat wire edgewise into a spiral,
each of the plurality of second turns includes:
a second inner peripheral portion that constructs an inner periphery side of the second turn in the flat wire; and
a second outer peripheral portion that constructs an outer periphery side of the second turn in the flat wire, and
each second outer peripheral portion is bent so as to be inclined with respect to the second inner peripheral portion in a second direction in the axial direction of the first coil portion.

4. The coil according to claim 3,
further comprising at least one third turn produced by edgewise winding of the flat wire between the first coil portion and the second coil portion,
wherein in each third turn, a third inner peripheral portion, which constructs an inner periphery side of the third turn in the flat wire, and a third outer peripheral portion, which constructs an outer periphery side of the third turn in the flat wire, are flatly connected.

5. The coil according to claim 3,
wherein the second coil portion is shaped as a quadrangular cylinder,
each second turn includes corner portions where the flat wire is bent edgewise, and
a displacement in the axial direction of the second coil portion between the second inner peripheral portion and the second outer peripheral portion at the corner portions is 0.1 mm or more and 0.5 mm or less.

6. A reactor comprising:
the coil according to claim 1; and
a magnetic core in which the coil is disposed.

7. A converter comprising the reactor according to claim 6.

8. A power conversion device comprising the converter according to claim 7.

9. A method for manufacturing a coil comprising a step of forming a plurality of first turns by winding a flat wire edgewise into a spiral using a winding machine,
wherein the winding machine includes a holding unit configured to hold an inner peripheral portion, which is positioned on an inner periphery side of a bend in the flat wire, and a guiding unit configured to hold the outer peripheral portion, which is positioned on an outer periphery side of the bend in the flat wire, during edgewise bending of the flat wire,
the holding unit includes a shaft that contacts a side surface of the inner peripheral portion,
the guiding unit is rotatable about a center axis of the shaft, and
the step of forming the first turns is performed in a state where the guiding unit is displaced with respect to the holding unit in a first direction in an axial direction of the shaft.

10. The method for manufacturing a coil according to claim 9,
wherein in the step of forming the first turns, a displacement in the first direction of the guiding unit with the holding unit as a reference is 0.1 mm or more and 0.5 mm or less.

11. The method for manufacturing a coil according to claim 9,
further comprising, after the step of forming the first turns, a step of forming a plurality of second turns by winding the flat wire edgewise into a spiral,
wherein the step of forming the second turns is performed in a state where the guiding unit is displaced with respect to the holding unit in a second direction in the axial direction of the shaft.

12. The method for manufacturing a coil according to claim 11,
further comprising, between the step of forming the first turns and the step of forming the second turns, a step of forming at least one third turn by edgewise winding of the flat wire,
wherein the step of forming the third turns is performed in a state where a position of the holding unit and a position of the guiding unit match in the axial direction of the shaft.

13. The method for manufacturing a coil according to claim 11,
wherein in the step of forming the second turns, a displacement in the second direction of the guiding unit with the holding unit as a reference is 0.1 mm or more and 0.5 mm or less.
